(19) United States
(12) Patent Application Publication
(10) Pub. No.: US 2002/0169271 A1
(43) Pub. Date: Nov. 14, 2002

(54) Adhesive mixture for bonding fluorohydrocarbon film to fibrous cementitious materials

(76) Inventors: Weiling Peng, Alta Loma, CA (US); Jeffrey Bergh, Long Beach, CA (US)

Correspondence Address: KNOBBE MARTENS OLSON & BEAR LLP, 2040 MAIN STREET, FOURTEENTH FLOOR, IRVINE, CA, 91614, US

(21) Appl. No.: 10/055,214

(22) Filed: Oct. 24, 2001

Related U.S. Application Data
(60) Provisional application No. 60/243,761, filed on Oct. 26, 2000.

(51) Int. Cl. C08G 18/08; C08G 18/16

(52) U.S. Cl. 528/48

(57) ABSTRACT

An adhesive composition adapted to bond a fluorohydrocarbon film to a substrate for exterior applications, such as roofing, panels, siding, trim, and the like. The adhesive mixture generally comprises a one component moisture cure polyurethane or polyurea adhesive composition having a reactive isocyanate compound, one or more catalysts that are capable of catalyzing the reaction of isocyanate and hydroxyl functional groups in the presence of moisture. The adhesive mixture can also comprise a two component polyurethane or polyurea composition including a reactive isocyanate compound, a polyol or polyamine, one or more catalysts.

### RELATED APPLICATIONS

This application claims the benefit of U.S. Provisional Application No. 60/243,761, filed on Oct. 26, 2000 and is hereby incorporated by reference in its entirety.

### BACKGROUND OF THE INVENTION

1. Field of the Invention

The present invention relates to adhesives, and more particularly, to a durable, rapidly setting, and non-VOC adhesive mixture that is especially suitable for use in bonding a protective fluorohydrocarbon film to a fiber cement substrate.

2. Description of the Related Art

Fiber cement in recent years has become popular for use as a building material, In many instances, fiber cement is preferred over the more conventional materials such as wood, metal, or plastics. When compared with wood, fiber cement has better water resistance and is also less prone to rotting, cracking or splitting. Moreover, fiber cement does not rust like metal and is more durable to weathering than plastics. In particular, fiber cement products such as James Hardie Building Products' HARDIPLANK® offer a lifetime of low maintenance and can be installed just as easily as wood sidings.

Advantageously, fiber cement can withstand extended exposure to humidity, rain, snow, salt air, and termites. It is also dimensionally stable and will not crack, rot, or delaminate under normal environmental conditions. Moreover, fiber cement panels may be pretextured or embossed to give the panel a desired look and feel. The panels may, for instance, be textured to resemble the look and warmth of natural wood. As such, fiber cement siding is a durable, attractive alternative to traditional wood composite, cedar, vinyl, brick or stucco sidings. Additionally, fiber cement is also an inexpensive alternative to conventional roofing materials such as corrugated aluminum sheets, which can be costly and energy intensive.

In some cases, the exterior surface of fiber cement panels is painted or subject to other types of post-production or on-site finishing to give the material the desired exterior appearance and feel for a particular application. Disadvantageously, however, natural weathering and other environmental factors can lead to chalking of the exposed paint surface and loss of polymer in the paint film. Moreover, the paint layers are typically very thin, generally on the order of one to two mils, and therefore are particularly susceptible to chipping, peeling, and scratching from surface abuse. Furthermore, the exterior of some building materials such as fiber cement can absorb up to about 30% water by weight, which may cause the fiber cement to experience freeze-thaw during the winter and become damaged.

To improve the durability of the exterior surface of building materials, manufacturers sometimes bond protective films to the exposed surface so that it can better withstand exposure to the elements. The films can also be used to increase the aesthetics of the building material. One commonly used protective film is a polyvinyl fluoride (PVF) film manufactured by DuPont under the trademark TEDLAR®, which has proven to be very durable for exterior applications. However, the adhesives used to bond TEDLAR® films to building material substrates are generally undesirable, particularly for bonding the film to fiber cement substrates.

In particular, conventional adhesives typically do not provide durable adhesion between TEDLAR® and fiber cement because fluorohydrocarbon films such as TEDLAR® are generally not easy to wet and to form bonds with another surface. Moreover, fiber cement has weak surface layers that can be easily peeled off if the selected adhesive cannot strongly adhere to the fiber cement. Furthermore, these adhesives generally take an undesirably long time to set, thereby causing a reduction in production throughput. Additionally, the adhesives also contain volatile organic chemicals (VOCs) that have shown to cause adverse effects on the environment.

Hence, from the foregoing, it will be appreciated that there is a need for an adhesive system that is adapted to form a durable bond between a fluorohydrocarbon film and a substrate surface. Furthermore, it will be appreciated that there is a need for a fast-setting adhesive that does not contain volatile organic chemicals (VOCs). To this end, there is a particular need for a fast-setting, non-VOC, and durable adhesive system for bonding a TEDLAR® film to a substrate such as fiber cement.

### SUMMARY OF THE INVENTION

The aforementioned needs are satisfied by the adhesive system of the preferred embodiments of the present invention which is adapted for bonding a fluorohydrocarbon film to a building material substrate. In one aspect, the adhesive system comprises a one component polyurethane or polyurea adhesive composition including a reactive isocyanate compound and one or more catalysts. Preferably, the isocyanate compound wets the fluorohydrocarbon film and forms a physical bond with the film. Preferably, the catalyst catalyzes a reaction that forms a chemical bond between the isocyanate compound in the adhesive mixture and the hydroxyl functional groups in the substrate. In one embodiment, the adhesive system further comprises a plasticizer that modifies the rheological characteristics of the adhesive. In yet another embodiment, the adhesive system includes a defoamer surfactant that reduces the occurrence of blisters in the adhesive. Furthermore, the adhesive composition may also comprise additives such as antioxidant, moisture scavenger, UV absorber, and/or heat stabilizer to improve the durability of the adhesive.

In another aspect, the adhesive system of the preferred embodiments of the present invention comprises a two component polyurethane adhesive composition including a reactive isocyanate compound, a polyol containing hydroxyl functional groups, one or more catalysts, and optionally a plasticizer, a defoamer surfactant, a moisture scavenger, an antioxidant, a UV absorber, and heat stabilizer. Preferably, the catalyst is adapted to catalyze a reaction between isocyanate and hydroxyl functional groups so as to form a polyurethane based polymer that will physically interlock and bond with the fluorohydrocarbon film and the substrate. In one embodiment, the polyol may be substituted by a polyamine so as to form a two component polyurea adhesive system.

Advantageously, the adhesive system of the preferred embodiments of the present invention provide excellent adhesion for laminating a fluorohydrocarbon film to fiber cement as well as other substrates such as wood, metals, and plastics. Furthermore, the preferred adhesives do not contain any measurable amounts of volatile organic chemicals (VOCs) and therefore do not pose threats to the environment or worker's health. Furthermore, the preferred adhesive system provides a fast working time and set time so as to increase the manufacturing throughput. These and other objects and advantages of the preferred embodiments of the present invention will become apparent from the following description.

### DETAILED DESCRIPTION OF THE PREFERRED EMBODIMENTS

The adhesive system of the preferred embodiments of the present invention provides a means for forming a durable bond between a fluorohydrocarbon film and a substrate such as fiber cement. In particular, the adhesive system can be used to bond a polyvinylfluoride (PVF) film such as TEDLAR® to a fiber cement substrate. As described in greater detail hereinbelow, the adhesive system of the preferred embodiments may comprise a one component moisture-cure polyurethane or polyurea adhesive or a two component polyurethane or polyurea adhesive.

One Component Moisture Cure Polyurethane or Polyurea Adhesive

In one preferred embodiment, the adhesive system generally comprises a moisture-cure polyurethane or polyurea adhesive composition having a reactive isocyanate compound and a catalyst. The isocyanate compound may be any aromatic, aliphatic, cycloaliphatic, acrylaliphatic, or heterocyclic isocyanate or polyisocyanate, and the prepolymers or mixtures thereof. In one embodiment, the isocyanate compound comprises an isocyanate group terminated prepolymer synthesized from an aromatic or aliphatic isocyanate. Preferably, the prepolymer is synthesized from isocyanate monomer or polyisocyanate with organic compound which has at least two active hydrogen containing functional groups. The active hydrogen containing functional groups may be selected from the group consisting of —COOH, —OH, —NH₂, —NH—, —CONH₂, —SH, and —CONH—.

Preferably, the isocyanate is of aromatic or aliphatic type and has a pH level between about 6.5 and 7.5, more preferably between about 6.8 and 7.2. Preferably, the isocyanate compound present in the adhesive composition has an —NCO functional group that is approximately between 10% and 33% by weight of the total weight of the polymer, more preferably between about 30% and 33% by weight. Furthermore, the isocyanate polymer has functionality preferably between about 2.0 and 3.5, with an average functionality of at least 2.0, and has a viscosity between about 200 centipoise (CPS) and 200,000 CPS, more preferably between about 200 CPS and 3,000 CPS to attain optimum wetting of the fluorohydrocarbon film.

Preferably, the isocyanate compound mechanically interlocks with the pores and contours on the fluorohydrocarbon film and forms a plurality of physical bonds with the film. In one embodiment, the isocyanate compound comprises an isocyanate group terminated prepolymer having reacted with at least two active hydrogen containing functional groups, such as —COOH, —OH, —NH₂, —NH—, —CONH₂, —SH, and —CONH—. Suitable isocyanate group terminated prepolymers include Desmodur E-28 available from Bayer of Pittsburgh, Pa.; UR-0222 MF available from H. B. Fuller of St. Paul, Minn. Suitable liquid isocyanate terminated adhesives include Rubinate M available from Huntsman Polyurethanes, Mich. of Sterling Heights, Mich.; Mondur MR, Mondur MRS, Mondur MRS-4, and Mondur MR200, available from Bayer; Papi 94, Papi 27, Papi 20 available from Dow Chemical of Midland, Mich. Suitable aliphatic isocyanates include Desmodur XP-7100 (Bayer), Desmodur N-3400 (Bayer) and Desmodur N-3300 (Bayer).

Preferably, the adhesive composition also comprises one or more catalysts known in the art such as tetra amines, metal salts, and any combinations thereof. The metal salts may include tin carboxylate, organosilicon titanates, alkyl titanates, bismuth carboxylates, zinc carboxylates, zinc-based salt, tin-based salt catalyst and the like. Preferably, the adhesive system comprises approximately 0.005% to 5% of catalyst by weight. Preferably, the catalyst is capable of catalyzing a reaction between the isocyanate and hydroxyl functional groups in the fiber cement in the presence of moisture so as to form a chemical bond between the isocyanate compound in the adhesive mixture and the hydroxyl functional groups in the substrate. Instead of providing a second adhesive component that contains hydroxyl functional groups to react with the isocyanate, the preferred one-component adhesive system uses the hydroxyl functional groups that are already present on the exterior surface of the substrate. Preferably, the hydroxyl functional groups on the substrate react with the isocyanate compound to form chemical bonds. This obviates the need of providing an additional second adhesive component as a source for hydroxyl functional groups. In one embodiment, the catalyst present in the adhesive system is a bismuth-based salt having a bismuth concentration between approximately 0.3% to 20% by weight.

In another embodiment, the adhesive system further comprises a plasticizer that allows for modification of the rheological characteristics of the adhesive. Preferably, a plasticizer such as alkyl phthalates (dioctylphthalate or dibutylphthalate), trictyl phosphate, epoxy plasticizers, toluene-sulfamide, chloroparaffins, adipics acid esters, castor oil, toluene and alkyl naphthalenes may be used for a polyurethane adhesive system. The amount of plasticizer is preferably between about 0% and 50% by weight. In yet another embodiment of the present invention, the adhesive system further includes a defoamer surfactant that allows for the modification of blister characters in the adhesive. Preferably, the defoamer can be between about 0% and 5% by weight. In yet another embodiment, the adhesive system further comprises additives such as antioxidant, UV absorber, and heater stabilizer wherein the additives preferably comprise approximately 0% to 5% by weight of the adhesive system. Advantageously, the one component adhesive of the preferred embodiments forms a durable bond between the fluorohydrocarbon film and the substrate and has a quick set time of 20 to 300 seconds at 350° F. The one component moisture-cure polyurethane or polyurea adhesive composition can be used to bond a fluorohydrocarbon film to a fiber cement substrate. Generally, the adhesive is applied to either a surface of the film or a surface of the fiber cement substrate. The film is then placed on the fiber cement in a manner such that the adhesive layer is interposed therebetween. The film is subsequently bonded to the fiber cement using a known lamination process. In one embodiment, a padding material such as a sheet of rubber may be placed adjacent the nonadhesive side of the film during the lamination process. The following examples are illustrative embodiments of the one component moisture-cure polyurethane or polyurea adhesive composition used in the context of laminating a fluorohydrocarbon film to a substrate. However, it can be appreciated that these examples are for illustrative purposes only and are not intended to limit the scope of the invention.

### EXAMPLE 1

A preferred composition of the one-component moisture cure polyurethane adhesive comprises 100 g of an aromatic polymeric isocyanate such as Rubinate M available from Huntsman Polyurethanes, MI, mixed with 0.2 g of a tin-based catalyst such as Metacure T12 catalyst available from Air Products and Chemicals, Inc., PA. Applicant has used this adhesive composition to bond a TEDLAR® film to a textured fiber cement substrate.

In particular, approximately 0.5 g of this adhesive mixture was applied, by brush, onto a top surface of the fiber cement substrate. The substrate was approximately 2 inch×6 inch and had a 5/16 inch thickness and a moisture content of about 6% by weight. A TEDLAR® film having a thickness of 0.0015 inches was subsequently placed on the top surface of the fiber cement substrate where the adhesive was applied. The stack comprised of the TEDLAR® film, adhesive, and fiber cement substrate was subsequently pressed at 225° F., 600 psi for 3 minutes to laminate the film to the substrate. Additionally, a padding material comprised of a sheet of rubber having a 1/16 inch thickness and 30 durometer shore A hardness was placed on the top surface of the nonadhesive side of the TEDLAR® film during the lamination process.

### EXAMPLE 2

Another preferred composition of the one-component moisture cure polyurethane adhesive comprises 100 g of an aliphatic isocyanate such as Desmodur XP7100 available from Bayer of Pittsburgh, Pa., mixed with 0.4 g of a tin-based catalyst such as Metacure T12 available from Air Products and Chemicals, Inc., PA. Applicant also has used this particular composition to bond a TEDLAR® film to a fiber cement substrate.

In particular, approximately 0.5 g of this adhesive mixture was applied, by brush, on a first surface of a 2 inch×6 inch TEDLAR® film having a thickness of 0.0015 inches. The TEDLAR® film was then placed on a top surface of a ¼ inch thick flat fiber cement substrate with the first surface of the TEDLAR® film coming into contact with the top surface of the substrate. The stack comprised of the TEDLAR® film, adhesive, and fiber cement substrate was subsequently pressed at 350° F., 600 psi for 5 minutes to laminate the film to the substrate. Additionally, a padding material such as a sheet of rubber having a 1/16 inch thickness and 30 durometer hardness was placed on the top surface of the nonadhesive side of the TEDLAR® film during the lamination process.

Two Component Polyurethane or Polyurea Adhesive

In another preferred embodiment, the adhesive system generally comprises a two component polyurethane adhesive composition including a reactive isocyanate compound, a polyol, a catalyst, and optionally a plasticizer, a defoamer surfactant, a moisture scavenger, an antioxidant, a UV absorber, and heat stabilizer. Preferably, the catalyst is capable of catalyzing a reaction between the isocyanate compound and the hydroxyl functional groups contained in the polyol to form a polyurethane based polymer. In one embodiment, the polyurethane based polymer interlocks with the pores and contours on the film and substrate so as to form a plurality of physical bonds with the film and substrate. In another embodiment, the isocyanate compound reacts with the hydroxyl functional groups in the fiber cement substrate to form a plurality of chemical bonds with the substrate.

Preferably, the isocyanate compound comprises approximately 25% to 75% of the adhesive composition by weight, more preferably 40% to 60%. Preferably, the isocyanate compound is of aromatic or aliphatic type, and has between about 10% to 33% NCO functional group by weight, more preferably between about 30% and 33%. Preferably, the isocyanate has a pH level between about 6.5 and 7.5, more preferably between about 6.8 and 7.2. Preferably, the isocyanate compound present in the adhesive system has functionality between about 2.0 and 3.5 and has a viscosity between about 200 centipoise (CPS) and 200,000 CPS, more preferably between about 200 CPS and 3,000 CPS.

Suitable isocyanate compounds that can be used in the two component adhesive composition include liquid isocyanates such as Rubinate M available from Huntsman of Sterling Heights, Mich.; Mondur MR, Mondur MRS, Mondur MRS-4, and Mondur MR200 available from Bayer of Pittsburgh, Pa.; Papi 94, Papi 27, and Papi 29 available from Dow Chemical of Midland, Mich.; and isocyanate group terminated prepolymers, such as Desmodur E-28 available from Bayer, UR-0222 Mf available from H. B. Fuller; and aliphatic isocyanates such as Desmodur XP-7100, Desmodur N-3400, and Desmodur N-3300 from Bayer.

The two component adhesive also comprises a polyol that comprises between about 25% and 75% by weight, more preferably between about 40% and 60% by weight of the adhesive composition. Preferably, the polyol present in the adhesive composition has a molecular weight between about 200 and 5,000 and a functionality between about 2.0 and 4.0, more preferably about 3.0. Preferably, the polyol has a viscosity between about 100 CPS and 30,000 CPS, more preferably between about 100 CPS and 500 CPS. Preferably, the polyol has a pH level between about 6.5 and 7.5, more preferably about 7.0. Suitable polyol compounds include Jeffol available from Huntsman of Sterling Heights, Mich.; Desmophen available from Bayer; Varanol available from Dow Chemical Co.

In an alternative embodiment, polyol may be substituted by a polyamine having substantially the specifications as the above described polyol with the exception of pH level, thus forming a two component polyurea adhesive system. Suitable polyamine compounds include Jeffamine available from Huntsman. The catalysts used for the two component polyurethane or polyurea adhesive system are preferably the same as those used for the one component moisture cure polyurethane adhesives. Likewise, the plasticizer, defoamer surfactant, moisture scavenger, antioxidant, UV absorber, and heat stabilizer in the two component adhesive systems are substantially the same as those used in the one-component adhesive system. Furthermore, in preferred embodiments, the two component adhesive systems have a set time of about 1 to 120 minutes at room temperature and about 5 to 120 seconds at 350° F., more preferably about 5 to 30 seconds at 350° F.

A preferred method for preparing the two component adhesive system comprises a first step wherein polyol or polyamine is mixed with the catalyst, and optionally with the plasticizer, defoamer, moisture scavenger, antioxidant, UV absorber, heat stabilizer to form a mixture. A second step involves mixing isocyanate with the mixture prepared in the first step for an amount of time that is sufficient to form an adhesive mixture for use but less than the pot life of the adhesive mixture. The pot life of the adhesive can be measured by using an industry standard procedure which involves measuring the viscosity of the adhesive mixture using a viscometer such as that provided by Brookfield.

### EXAMPLE 3

A preferred composition of the two component polyurethane adhesive system includes a first component and a second component. The first component comprises 100 g of an aromatic polymeric isocyanate such as Rubinate M available from Huntsman Polyurethanes, MI. The second component comprises 100 g of a polyol such as Voranol 230-238 available from Dow Chemical Company mixed with 0.2 g of a bismuth and zinc based catalyst such as Bicat 8 from Shepherd Chemical Company, OH. The first and second components were then mixed to form an adhesive mixture. Applicant has used this adhesive mixture to bond a TEDLAR® film to a textured fiber cement substrate.

In particular, approximately 0.4 g of this mixture was applied, by brush, onto a top surface of a 2 inch×6 inch textured fiber cement substrate having a 5/16inch thickness and approximately 12% moisture content. A sheet of precoat 68080 TEDLAR® film having a thickness of 0.0017 inches was then placed on the top surface of the fiber cement substrate. The stack comprised of the TEDLAR® film, adhesive, and fiber cement substrate was subsequently pressed at 300° F., 45 psi for 30 seconds to laminate the film to the substrate. Additionally, a padding material such as a sheet of rubber having a ⅛inch thickness and 50 durometer hardness was placed on the top surface of the nonadhesive side of the TEDLAR® film during the lamination process.

The laminated substrates from Examples 1, 2, and 3 all showed strong adhesion between the TEDLAR® film and the fiber cement and no blisters were present between the TEDLAR® film and the fiber cement substrate. Adhesion is evaluated by testing the peel strength of the laminated panels in accordance with ASTM D903. The peel strength is greater than or equal to 17 lb/in. for panels from Examples 1, 2 and 3, and all failures involved cohesive ripping of the TEDLAR® film.

Furthermore, the adhesion between TEDLAR® and fiber cement did not deteriorate even after being subject to various boiling, freeze-thaw, wet-dry, and boiling-dry cycling tests. In particular, in the boiling test, three samples were placed in boiling water for one thousand hours and then subject to adhesion testing. In the freeze-thaw test cycle, three samples were fully immersed in water within a container while the container was frozen at a temperature of −20° C. for at least 1 hour and then thawed to about 20° C. for at least 1 hour. This freeze-thaw cycle was repeated for 15 times before the samples were tested for adhesion. In the wet-dry test cycle, three samples were soaked in water for 24 hours and dried at 60° C. for 24 hours. This wet-dry cycle was then repeated 50 times before adhesion was tested. In the boiling-dry cycling test, four test specimens were submerged in boiling water for 2 hours and dried in an over at 140° F. for 22 hours. This boiling-dry cycle was repeated for five times before subjecting the specimens to adhesion testing.

Advantageously, the adhesives of the preferred embodiments provide excellent adhesion durability between the fluorohydrocarbon film and fiber cement substrate. Furthermore, the adhesives demonstrate a fast working time and set time so as to permit the fluorohydrocarbon film to be quickly bonded to the fiber cement substrate, which in turn increases throughput in the manufacturing process. Furthermore, the adhesives effectively transmit detailed surface texture definition on the fiber cement substrate through to the fluorohydrocarbon film by creating a bond between the TEDLAR® film and the fiber cement substrate that is strong enough to permit the film to be stretched tightly before positioning it onto the substrate. As a result, the detailed texture definition on the surface of the fiber cement substrate is transmitted through to the TEDLAR® film.

Furthermore, unlike conventional adhesives used to bond fluorohydrocarbon films, the adhesives of the preferred embodiments do not contain measurable amounts of volatile organic chemicals (VOCs). As such, health and safety related issues surrounding the use of the adhesives are substantially reduced. Furthermore, the adhesives provide a cost-effective way of bonding the fluorohydrocarbon film to a fiber cement substrate as the constituent components and method of making the adhesive mixtures are relatively inexpensive.

Although the above examples illustrate using the adhesive compositions to bond TEDLAR® films to fiber cement substrates, it can be appreciated that the adhesive system may be adapted to bond fluorohydrocarbon films to other substrates including but not limited to wood, metals such as aluminum, concrete and other cementitious materials, plastics such as polyvinyl chloride, composite materials such as fiber reinforced plastic, engineered wood materials such as hardboard or oriented strand board and gypsum board.

Although the foregoing description of the preferred embodiments of the present invention has shown, described and pointed out the fundamental novel features of the invention, it will be understood that various omissions, substitutions, and changes in the form of the detail of the apparatus as illustrated as well as the uses thereof, may be made by those skilled in the art, without departing from the spirit of the invention. Consequently, the scope of the invention should not be limited to the foregoing discussions, but should be defined by the appended claims.

What is claimed is:

1. An adhesive system for bonding a fluorohydrocarbon film to a building material substrate having hydroxyl functional groups, comprising:
an isocyanate compound that is adapted to wet the fluorohydrocarbon film and form a physical bond with the film; and
a catalyst wherein the catalyst catalyzes a reaction between the isocyanate compound and the hydroxyl functional groups present in the substrate so as to form a chemical bond between the isocyanate compound and the hydroxyl functional groups in the substrate.

2. The adhesive system of claim 1 wherein the isocyanate compound comprises an aromatic isocyanate.

3. The adhesive system of claim 1 wherein the isocyanate compound comprises an isocyanate group terminated prepolymer synthesized from an aromatic isocyanate.

4. The adhesive system of claim 3 wherein the prepolymer is synthesized from isocyanate and an organic compound, wherein the organic compound has at least two active hydrogen containing functional groups.

5. The adhesive system of claim 4 wherein the active hydrogen containing functional groups are selected from the group consisting of —COOH, —OH, —NH₂, —NH—, —CONH₂, —SH, and —CONH—.

6. The adhesive system of claim 1 wherein the isocyanate compound comprises an aliphatic isocyanate.

7. The adhesive system of claim 1 wherein the isocyanate compound comprises an isocyanate group terminated prepolymer synthesized from an aliphatic isocyanate.

8. The adhesive system of claim 7 wherein the prepolymer is synthesized from isocyanate and an organic compound, wherein the organic compound has at least two active hydrogen containing functional groups.

9. The adhesive system of claim 8 wherein the hydrogen containing functional groups are selected from the group consisting of —COOH, —OH, —NH₂, —NH—, —CONH₂, —SH, and —CONH—.

10. The adhesive system of claim 1 wherein the isocyanate compound comprises between about 10% and 33% by weight NCO functional group.

11. The adhesive system of claim 1 wherein the isocyanate compound has functionality between about 2.0 and 3.5.

12. The adhesive system of claim 1 wherein the isocyanate compound has a viscosity between about 200 centipoise and 200,000 centipoise.

13. The adhesive system of claim 1 wherein the catalyst comprises between about 0.005% and 5% by weight of the adhesive system.

14. The adhesive system of claim 1 wherein the catalyst comprises a bismuth-based salt.

15. The adhesive system of claim 1 wherein the catalyst comprises a zinc-based salt.

16. The adhesive system of claim 1 wherein the catalyst comprises a tin-based salt.

17. The adhesive system of claim 1 further comprises a plasticizer.

18. The adhesive system of claim 17 wherein the plasticizer comprises an alkyl phthalate.

19. The adhesive system of claim 1 further comprises a defoamer and a moisture scavenger.

20. The adhesive system of claim 1 further comprises an antioxidant, a UV absorber, and a heat stabilizer.

21. The adhesive system of claim 1 wherein the building material substrate comprises a fiber cement material.

22. The adhesive system of claim 21 wherein the fluorohydrocarbon film comprises a polyvinyl fluoride film.

23. The adhesive system of claim 1 wherein the building material substrate comprises wood.

24. An adhesive system for bonding a fluorohydrocarbon film to a building material substrate, comprising:
an isocyanate compound that is adapted to wet the fluorohydrocarbon film and form a physical bond with the film;
a polyol containing hydroxyl functional groups; and
a catalyst wherein the catalyst catalyzes a reaction between the isocyanate compound and hydroxyl functional groups so as to form a polyurethane based polymer wherein the polymer physically interlocks and bonds with the film and the substrate.

25. The adhesive system of claim 24 wherein the isocyanate compound comprises an aromatic isocyanate.

26. The adhesive system of claim 24 wherein the isocyanate compound comprises an isocyanate group terminated prepolymer synthesized from an aromatic isocyanate.

27. The adhesive system of claim 26 wherein the prepolymer is synthesized from isocyanate and an organic compound, wherein the organic compound has at least two active hydrogen containing functional groups.

28. The adhesive system of claim 27 wherein the active hydrogen containing functional groups are selected from the group consisting of —COOH, —OH, —NH₂, —NH—, —CONH₂, —SH, and —CONH—.

29. The adhesive system of claim 24 wherein the isocyanate compound comprises an aliphatic isocyanate.

30. The adhesive system of claim 29 wherein the isocyanate compound comprises an isocyanate group terminated prepolymer synthesized from an aliphatic isocyanate.

31. The adhesive system of claim 30 wherein the prepolymer is synthesized from isocyanate and an organic compound, wherein the organic compound has at least two active hydrogen containing functional groups.

32. The adhesive system of claim 31 wherein the hydrogen containing functional groups are selected from the group consisting of —COOH, —OH, —NH₂ and —CONH₂, —SH, and —CONH—.

33. The adhesive system of claim 24 wherein the isocyanate compound comprises between about 10% and 33% by weight NCO functional group.

34. The adhesive system of claim 27 wherein the isocyanate compound has functionality between about 2.0 and 3.5.

35. The adhesive system of claim 28 wherein the isocyanate compound has a viscosity between about 200 centipoise and 200,000 centipoise.

36. The adhesive system of claim 24 wherein the catalyst comprises between about 0.005% and 5% by weight of the adhesive system.

37. The adhesive system of claim 24 wherein the catalyst comprises a bismuth-based salt.

38. The adhesive system of claim 24 wherein the catalyst comprises a zinc-based salt.

39. The adhesive system of claim 24 wherein the catalyst comprises a tin-based salt.

40. The adhesive system of claim 24 further comprises a plasticizer.

41. The adhesive system of claim 40 wherein the plasticizer comprises an alkyl phthalate.

42. The adhesive system of claim 24 further comprises a defoamer and a moisture scavenger.

43. The adhesive system of claim 24 further comprises an antioxidant, a TV absorber, a heat stabilizer.

44. The adhesive system of claim 24 wherein the building material substrate comprises a fiber cement material containing hydroxyl functional groups wherein the catalyst is adapted to catalyze a reaction between the isocyanate compound and the hydroxyl functional groups in the substrate so as to form a chemical bond between the isocyanate compound and the hydroxyl functional groups in the substrate.

45. The adhesive system of claim 24 wherein the building material substrate comprises wood.

46. The adhesive system of claim 24 wherein the building substrate comprises a metal material.

47. The adhesive system of claim 24 wherein the building substrate comprises a plastics material.

48. An adhesive system for bonding a fluorohydrocarbon film to a building material substrate, comprising:
an isocyanate compound;
a polyamine; and
a catalyst wherein the catalyst is adapted to catalyze a reaction between the isocyanate compound and the hydroxyl functional groups present in the substrate.
